(19) United States
(12) Patent Application Publication
(10) Pub. No.: US 2020/0333918 A1
(43) Pub. Date: Oct. 22, 2020

(54) FLEXIBLE TOUCH DISPLAY PANEL

(71) Applicant: Wuhan China Star Optoelectronics Semiconductor Display Technology Co., Ltd., Wuhan, Hubei (CN)

(72) Inventors: Dan LIN, Wuhan, Hubei (CN); Qibing DAI, Wuhan, Hubei (CN); Miniun LIU, Wuhan, Hubei (CN); Jian YE, Wuhan, Hubei (CN)

(21) Appl. No.: 16/619,088

(22) PCT Filed: Feb. 20, 2019
(86) PCT No.: PCT/CN2019/075613

§ 371 Date: Dec. 4, 2019

(30) Foreign Application Priority Data
Dec. 21, 2018 (CN) 201811574507.2

(51) Int. Cl. G06F 3/044

(52) U.S. Cl. CPC G06F 3/0446; G06F 3/0443; G06F 2203/04111; G06F 2203/04102; G06F 3/0448

(57) ABSTRACT

A flexible touch display panel includes a touch electrode layer with an ITO material. The touch electrode layer includes a plurality of first touch electrodes disposed along a first direction and a plurality of second touch electrodes disposed along a second direction. The second touch electrodes are electrically insulated from and intersect with the first touch electrodes. The flexible touch display panel includes a bending area, and a first display area and a second display area respectively disposed on two opposite sides of the bending area. The first touch electrodes and the second touch electrodes are hollowed out or partially hollowed out in the bending area. Therefore, bending endurance of the touch electrode layer in the bending area can be enhanced, and the risk of cracking and cracking of the touch electrodes during bending is reduced, thereby reducing the risk of loss of touch functions of the display panel.

### FIELD OF INVENTION

The present invention relates to the field of touch display technologies, and in particular, to a flexible touch display panel.

### BACKGROUND OF INVENTION

Among flat panel display technologies, organic light-emitting diode (OLED) displays have excellent characteristics, such as being thin and light, active illumination, fast response times, wide viewing angles, wide color gamut, high brightness, low power consumption, and flexible screen preparation, which have aroused great interest in scientific researches and the industry, and gradually become the third generation display technology after liquid crystal displays (LCDs). Recently, flexible display devices that can display an image under bending conditions, such as paper, have become a focus of next-generation display devices by forming a display panel, wiring, or the like on a flexible substrate of a flexible material, such as plastic.

In addition, with development of portable electronic display devices, a touch panel provides a new human-computer interaction interface, which is more direct and more user-friendly in use. A touch screen and a flat display device are integrated to form a touch display device, which can enable the flat display device to have a touch function, and can perform input through a finger, a stylus, etc., and thus more intuitive and easier to operate.

At present, the most commonly used touch technologies include resistive touch panels and capacitive touch panels. For the sake of controllability, easy use and surface appearance, users often use capacitive touch panels as their best choice. In development of the existing OLED touch display technology, in view of the difficulty of the process, a touch sensor is generally fabricated on an OLED layer. The specific process is as follows. First, a TFT (Thin-Film Transistor) layer including a substrate is fabricated, then an OLED layer is formed on the TFT layer, an encapsulation layer is formed on the OLED layer, and finally a touch function layer is formed on the encapsulation layer. The touch function layer generally includes a first insulating layer, a bridge layer, a second insulating layer, an electrode circuit layer, and an organic protective layer disposed in order from bottom to top, wherein the bridge layer includes a plurality of metal bridges in a pixel region. The electrode circuit layer includes a touch driving electrode (Tx) and a touch sensing electrode (Rx), and the touch driving electrode or the touch sensing electrode is connected to the metal bridge through a contact hole penetrating the second insulating layer.

Materials of touch electrodes that have been developed and applied mainly include indium tin oxide (ITO), silver nanowires (SNW), and metal mesh. Among them, because a graphic line width of the touch conductive electrode of the metal mesh is thicker (the line width is more than 5 μm), a molar interference ripple is very obvious, and it is only suitable for a display screen with a long distance. The touch conductive electrodes of SNW often have a problem of high haze, and the haze increases with the use time, and the manufacturing cost is high. As the current mainstream touch electrode material, ITO has high transmittance and good electrical conductivity, but its bending resistance is poor. For the current foldable display with potential application, ITO touch electrodes will cause cracks by long-time bending, which will in turn cause the touch function to fail.

### SUMMARY OF INVENTION

An object of the present invention is to provide a flexible touch display panel capable of enhancing the bending resistance of the touch electrode layer in a bending area and avoiding loss of the touch function caused by breakage of the touch electrode.

To achieve the above objective, the present invention provides a flexible touch display panel including a bending area, and a first display area and a second display area respectively disposed on two opposite sides of the bending area.

The flexible touch display panel includes a touch electrode layer, and a material of the touch electrode layer is a transparent and electrically conductive material.

The touch electrode layer includes a plurality of first touch electrodes disposed along a first direction and a plurality of second touch electrodes disposed along a second direction, and the second touch electrodes being electrically insulated from and intersected with the first touch electrodes.

The first touch electrodes include a plurality of first touch units and connection units each connecting adjacent two first touch units.

The second touch electrodes include a plurality of independent second touch units.

The first touch electrodes and the second touch electrodes in the bending area are hollowed out or partially hollowed out.

The material of the touch electrode layer is ITO.

The shapes of the first touch units and the second touch units are diamond shapes, and the side lengths of the first touch units and the second touch units are 3-5 cm.

The bending area has a width of 1-5 cm.

The first touch electrodes and the second touch electrodes are partially hollowed out in the bending area to form a plurality of hollow patterns, and the hollow patterns are respectively formed at the first touch units, the connection units or the second touch units.

The edges of the first touch units, the connection units and the second touch units of the bending area are wavy.

The touch electrode layer further includes a plurality of floating electrode blocks disposed in the hollow pattern.

The number of the floating electrode blocks is less than the number of the hollow patterns, and the floating electrode blocks are respectively disposed in different hollow patterns; or

the number of the floating electrode blocks is the same as the number of the hollow patterns, and the floating electrode blocks are disposed one by one in the hollow patterns.

The hollow pattern has a shape of square, circular or diamond.

The first touch electrodes and the second touch electrodes in the bending area are entirely hollowed out.

The touch electrode layer further includes a plurality of floating electrode strips staggered in the bending area and perpendicular to the width direction of the bending area.

The beneficial effects of the invention: The flexible touch display panel of the present invention is divided into a bending area, and a first display area and a second display area respectively disposed on two opposite sides of the bending area. The flexible touch display panel includes a touch electrode layer made of a transparent conductive material. The touch electrode layer includes a plurality of first touch electrodes disposed along a first direction and a plurality of second touch electrodes disposed along a second direction, the second touch electrodes being electrically insulated from and intersected with the first touch electrodes. The first touch electrodes and the second touch electrodes in the bending area are hollowed out or partially hollowed out. Therefore, the bending endurance of the touch electrode layer in the bending area can be enhanced, and the risk of cracking and cracking of the touch electrodes during bending is reduced, thereby reducing the risk of loss of the touch function of the display panel.

In order to further understand the features and technical details of the present invention, reference should be made to the following detailed description of the invention. However, the drawings are provided for reference and description only and are not intended to limit the invention.

### DESCRIPTION OF DRAWINGS

The technical solutions and other advantageous effects of the present invention will be apparent from the following detailed description of embodiments of the invention.

In the drawings:

FIG. 1 is a schematic plan view showing a touch electrode layer in a flexible touch display panel according to a first embodiment of the present invention;

FIG. 2 is a partially enlarged schematic view showing the touch electrode layer in a bending area of the flexible touch display panel of the first embodiment of the present invention; and

FIG. 3 is a schematic plan view showing the touch electrode layer in the flexible touch display panel of a second embodiment of the present invention.

### DETAILED DESCRIPTION OF PREFERRED EMBODIMENTS

In order to further clarify the technical means and effects of the present invention, the following detailed description will be made in conjunction with the preferred embodiments of the invention and the accompanying drawings.

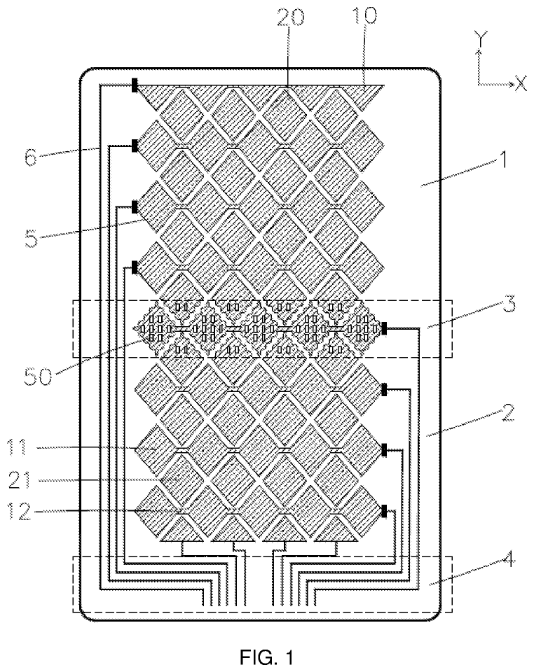

Referring to FIG. 1, a flexible touch display panel according to a first embodiment of the present invention includes a bending area 3, and a first display area 1 and a second display area 2 respectively disposed on two opposite sides of the bending area 3, and a circuit bonding area 4. The circuit bonding area 4 is disposed in the first display area 1 or the second display area 2, and is away from a side of the bending area 3.

The flexible touch display panel includes a metal bridge layer (not shown), an insulating layer (not shown), and a touch electrode layer 5, which are sequentially stacked, and an edge metal trace 6, which is used for connecting the touch electrode layer 5 to the circuit bonding area 4 in the layer where the touch electrode layer 5 disposed.

Material of the touch electrode layer 5 is indium tin oxide (ITO) of a transparent and electrically conductive material.

As shown in FIG. 1, the touch electrode layer 5 includes a plurality of first touch electrodes 10 disposed along a first direction X and a plurality of second touch electrodes 20 disposed along a second direction Y, and the second touch electrodes 20 being electrically insulated from and intersected with the first touch electrodes 10.

The first touch electrodes 10 include a plurality of first touch units 11 and connection units 12 each connecting adjacent two first touch units 11. The second touch electrode 20 includes a plurality of independent second touch units 21. The metal bridge layer includes a plurality of metal bridges corresponding to the intersections of the first touch electrodes 10 and the second touch electrodes 20, and the two ends of the metal bridge are respectively connected to the two adjacent second touch units 21 to connect the two second touch units 21.

The first touch electrodes 10 and the second touch electrodes 20 of the touch electrode layer 5 are partially hollowed out in the bending area 3 than in the first display area 1 and the second display area 2, which forms a plurality of hollow patterns 50, and thus improve the bending resistance of the touch electrode layer 5 in the bending area 3.

Specifically, the shape of the first touch units 11 and the second touch units 21 are diamond shapes, and the side lengths of the first touch units 11 and the second touch units 21 are 3-5 cm.

Specifically, the bending area 3 has a width of 1-5 cm.

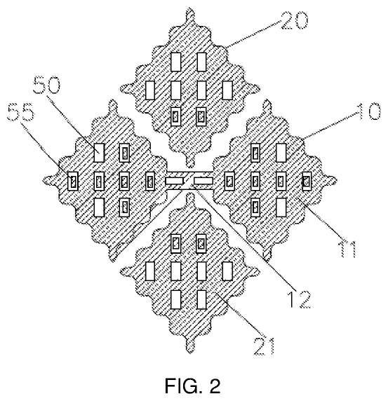

Specifically, as shown in FIG. 2, in the embodiment, the hollow patterns 50 are distributed on the first touch units 11, the connection units 12, and the second touch units 21 in the bending area 3.

Further, the edges of the first touch units 11, the connecting units 12 and the second touch units 21 of the bending area 3 are wavy compared to the conventional straight shape, so that the bending can be further decomposed. The stress resistance enhances the bending resistance of the first touch units 11, the connecting units 12, and the second touch units 21 in the bending area 3.

Specifically, the touch electrode layer 5 further includes a plurality of floating electrode blocks 55 disposed in the hollow pattern 50.

Further, the number of the floating electrode blocks 55 is less than the number of the hollow patterns 50, and each of the floating electrode blocks 55 is disposed in different hollow patterns 50.

Alternatively, the number of the floating electrode blocks 55 is the same as the number of the hollow patterns 50, and the floating electrode blocks 55 are disposed one by one in the hollow patterns 50.

Specifically, the hollow pattern 50 has a shape of a square, a circle or a diamond.

Specifically, the first touch electrode 10 is one of a touch driving electrode (Tx) and a touch sensing electrode (Rx), and the second touch electrode 20 is the other one of the touch driving electrode and the touch sensing electrode.

In the flexible touch display panel of the present embodiment, the first touch units 11, the connecting units 12, and the second touch units 21 respectively have a plurality of hollow patterns 50 in the bending area 3, so that the bending resistance can be improved. The edge of the first touch units 11, the connecting units 12, and the second touch units 21 is wavy in the bending area 3, so that the stress during bending can be further decomposed. Furthermore, the bending endurance of the first touch units 11, the connecting units 12, and the second touch units 21 in the bending area 3 can be enhanced, and the risk of cracking and cracking of the touch electrodes 5 during bending is reduced, thereby reducing the risk of loss of the touch function of the display panel.

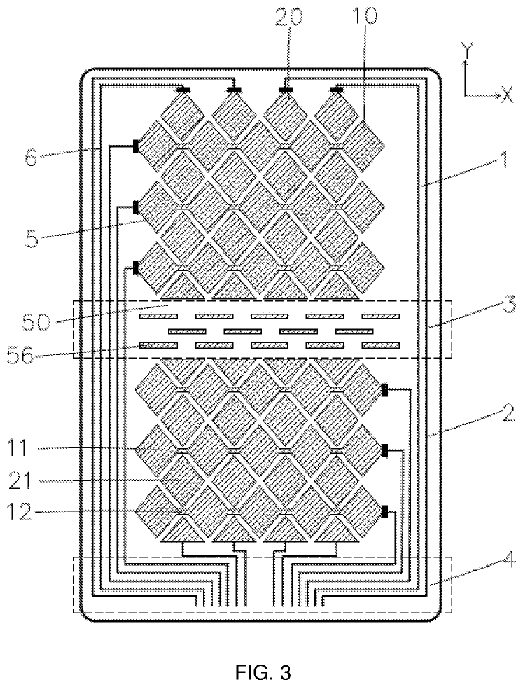

Referring to FIG. 3, the flexible touch display panel of the second embodiment of the present invention is different from the first embodiment in that, in this embodiment, the first touch electrodes 10 and the second touch electrodes 20 of the touch electrode layer 5 in the bending area 3 are hollowed out to form hollow patterns 50, so that the embodiment can cope with a higher degree of bending. The width of the bending area 3 is 1-2 cm or a greater number of bending times. The first touch electrodes 10 and the second touch electrodes 20 of the touch electrode layer 5 are hollowed out in the bending area 3, which is equivalent to the first touch electrodes 10 and the second touch electrodes 20 being disconnected in the bending area 3. At this time, the first touch electrodes 10 of the first display area 1 and the first touch electrodes 10 of the second display area 2 are respectively connected to the circuit bonding area 4 through different edge metal traces 6. The second touch electrodes 20 of the first display area 1 and the second touch electrodes 20 of the second display area 2 are respectively connected to the circuit bonding region 4 through different edge metal traces 6.

Further, the touch electrode layer 5 further includes a plurality of floating electrode strips 56 arranged in a chain shape perpendicular to the width direction of the bending area 3 staggered in the bending area 3 to disassemble the stress of the touch electrode layer 5 and enhance the bending resistance of the touch electrode layer 5 in the bending area 3. Other technical features are the same as those of the first embodiment described above, and are not described herein again.

In the flexible touch display panel of the present embodiment, the first touch electrodes 10 and the second touch electrodes 20 of the touch electrode layer 5 are integrally hollowed out in the bending area 3 to form hollow patterns 50, and the touch electrode layer 5 further includes the floating electrode strips 56 arranged in a chain shape perpendicular to the width direction of the bending area 3 staggered in the bending area 3 to disassemble the stress of the touch electrode layer 5, the bending endurance of the touch electrode layer 5 in the bending area 3 can be enhanced, and the risk of cracking and cracking of the touch electrodes 5 during bending is reduced, thereby reducing the risk of loss of the touch function of the display panel.

In summary, the flexible touch display panel of the present invention is divided into a bending area, and a first display area and a second display area respectively disposed on two opposite sides of the bending area. The flexible touch display panel includes a touch electrode layer, and material of the touch electrode layer is a transparent and electrically conductive material. The touch electrode layer includes a plurality of first touch electrodes disposed along a first direction and a plurality of second touch electrodes disposed along a second direction, the second touch electrodes being electrically insulated from and intersected with the first touch electrodes. The first touch electrodes and the second touch electrodes are hollowed out or partially hollowed out in the bending area. Therefore, the bending endurance of the touch electrode layer in the bending area can be enhanced, and the risk of cracking and cracking of the touch electrodes during bending is reduced, thereby reducing the risk of loss of the touch function of the display panel.

In the above, various other changes and modifications can be made in accordance with the technical solutions and technical concept of the present invention, and all such changes and modifications are within the scope of the claims of the present invention.

What is claimed is:

1. A flexible touch display panel, comprising: a bending area, and a first display area and a second display area respectively disposed on two opposite sides of the bending area;
wherein the flexible touch display panel includes a touch electrode layer, and material of the touch electrode layer is a transparent and electrically conductive material;
wherein the touch electrode layer includes a plurality of first touch electrodes disposed along a first direction and a plurality of second touch electrodes disposed along a second direction, the second touch electrodes electrically insulated from and intersected with the first touch electrodes;
wherein the first touch electrodes include a plurality of first touch units and connection units each connecting adjacent two first touch units;
wherein the second touch electrodes include a plurality of independent second touch units; and
wherein the first touch electrodes and the second touch electrodes in the bending area are hollow or partially hollow.

2. The flexible touch display panel as claimed in claim 1, wherein the material of the touch electrode layer is ITO.

3. The flexible touch display panel as claimed in claim 1, wherein the shapes of the first touch units and the second touch units are diamond shapes, and the side lengths of the first touch units and the second touch units are 3-5 cm.

4. The flexible touch display panel as claimed in claim 1, wherein the bending area has a width of 1-5 cm.

5. The flexible touch display panel as claimed in claim 1, wherein the first touch electrodes and the second touch electrodes are partially hollowed out in the bending area to form a plurality of hollow patterns, and the hollow patterns are respectively formed at the first touch units, the connection units or the second touch units.

6. The flexible touch display panel as claimed in claim 5, wherein edges of the first touch units, the connection units, and the second touch units of the bending area are wavy.

7. The flexible touch display panel as claimed in claim 5, wherein the touch electrode layer further includes a plurality of floating electrode blocks disposed in the hollow pattern.

8. The flexible touch display panel as claimed in claim 7, wherein the number of the floating electrode blocks is less than the number of the hollow patterns, and the floating electrode blocks are respectively disposed in different hollow patterns; or
the number of the floating electrode blocks is the same as the number of the hollow patterns, and the floating electrode blocks are disposed one by one in the hollow patterns.

9. The flexible touch display panel as claimed in claim 5, wherein the hollow pattern has a shape of a square, a circle or a diamond.

10. The flexible touch display panel as claimed in claim 1, wherein the first touch electrodes and the second touch electrodes in the bending area are entirely hollowed out; and
the touch electrode layer further includes a plurality of floating electrode strips staggered in the bending area and perpendicular to the width direction of the bending area.
